(19) United States
(12) Patent Application Publication
(10) Pub. No.: US 2006/0183370 A1
(43) Pub. Date: Aug. 17, 2006

(54) Device with a physical unit with at least two operating positions

(76) Inventor: Norbert Stampfl, Grossweikersdorf (AT)

Correspondence Address: PHILIPS INTELLECTUAL PROPERTY & STANDARDS, P.O. BOX 3001, BRIARCLIFF MANOR, NY, 10510, US

(21) Appl. No.: 10/550,879

(22) PCT Filed: Mar. 30, 2004
(86) PCT No.: PCT/IB04/50359

§ 371 Date: Sep. 27, 2005

(30) Foreign Application Priority Data
Mar. 31, 2003 (EP) 03100847.7

(51) Int. Cl. H01R 35/00

(52) U.S. Cl. 439/534

(57) ABSTRACT

A device (1) has a modular unit (6) which can be adjusted between at least two operating positions in the device (1) and which, in each operating position, can be accessed from outside the device (1).

Device with a physical unit with at least two operating positions The invention relates to a device with a modular unit, which modular unit is positioned in an operating position and can be accessed from outside the device.

A device as mentioned above is known, for example, in connection with an audio device having the type designation MC-i200, which audio device was made commercially available by the Applicant. The known audio device includes an Internet module, which Internet module makes it possible to receive radio transmissions, which radio transmissions are sent out over the Internet or over a packet switching network as a data stream. For this purpose, a network jack is fitted in the region of a casing wall of a casing of the known audio device in a manner such that it can be accessed from outside, so that a network connector can be plugged into the network jack, which network connector can be connected to the network via a network cable. The network jack is designed as an Ethernet connection and is fitted in the region of a rear wall of the casing and connected to the Internet module.

The fact that the Ethernet connection or the network jack is fitted in the region of the rear of the known audio device is on the one hand advantageous because there is good protection in this region against external influences, but on the other hand is disadvantageous with regard to simple and fast plugging in of the network connector since the user almost always has to handle or move the audio device in order to make it possible to connect the network connector in an easy or easily accessible manner. Such handling is inconvenient and often awkward, and is thus disadvantageous. This is the case in particular when the network connector, together with its associated network cable, is provided to be additionally connected to other devices for the purpose of producing a network connection, for example to a PC or to a laptop or to a small, portable audio device. Frequent or repeated changing over of the network connector between the various devices is then particularly impractical, and this is disadvantageous.

It is an object of the invention to overcome the problems mentioned above and to provide an improved device with a modular unit which can be accessed from outside the device.

In order to achieve the object mentioned above, a device according to the invention has features according to the invention, so that a device according to the invention can be characterized in the manner specified below, namely:

a device with a modular unit, which modular unit is positioned in an operating position and can be accessed from outside the device, characterized in that the modular unit can be positioned in at least one other operating position and in that case too can be accessed from outside the device.

By providing the features according to the invention, the advantage is obtained that a modular unit of a device according to the invention, which modular unit may for example be a network jack that can be accessed from outside the device, can be positioned at will in various operating positions and is thus always accessible, as a result of which, on the one hand, for example easier operation and handling can be achieved with the modular unit and/or the device, which is very practical and advantageous, or, on the other hand—if the modular unit is, for reasons that are desired, positioned initially, for example when the device is purchased, in an exposed or conspicuous and therefore sales-promoting operating position—the user of the device is given the opportunity to place the modular unit, for personal reasons, in a different operating position in which the modular unit is not exposed but is therefore well protected. It is also possible, in a device according to the invention, for a modular unit that was previously positioned in a manner well protected from external accesses thereafter to be placed in an operating position that is less well protected but can be reached easily and simply.

It has proven to be advantageous if additionally the feature as claimed in claim 2 is provided in a device according to the invention. This is particularly advantageous with regard to a simple constructional design for the positioning of the modular unit.

In a device according to the invention, the modular unit can be grasped manually in order to move the modular unit from one operating position into at least one other operating position, where the modular unit is held in each operating position by means of holding means. It has proven to be very advantageous if the features as claimed in claim 3 are provided. As a result, reliable and smooth adjustability is achieved.

It has proven to be very advantageous if additionally the feature as claimed in claim 4 is provided in a device according to the invention. This is particularly advantageous with regard to a simple and space-saving implementation or constructional design of the carrier of the modular unit.

Furthermore, it has proven to be advantageous if additionally the feature as claimed in claim 5 is provided in a device according to the invention. This is particularly advantageous with regard to simple positioning of the modular unit in a number of different operating positions.

In a device according to the invention, operating positions that are in each case not assumed can where appropriate be closed or covered by means of a suitable, separate matching piece which is in particular matched to the optical properties of the device. It has proven to be very advantageous if the features as claimed in claim 6 are provided. As a result, simple and reliable covering of the operating positions that are in each case not assumed is made possible.

The above-mentioned aspects and further aspects of the invention emerge from the examples of embodiments described below and are explained using these examples of embodiments.

The invention will be further described with reference to examples of embodiments shown in the drawings to which, however, the invention is not restricted.

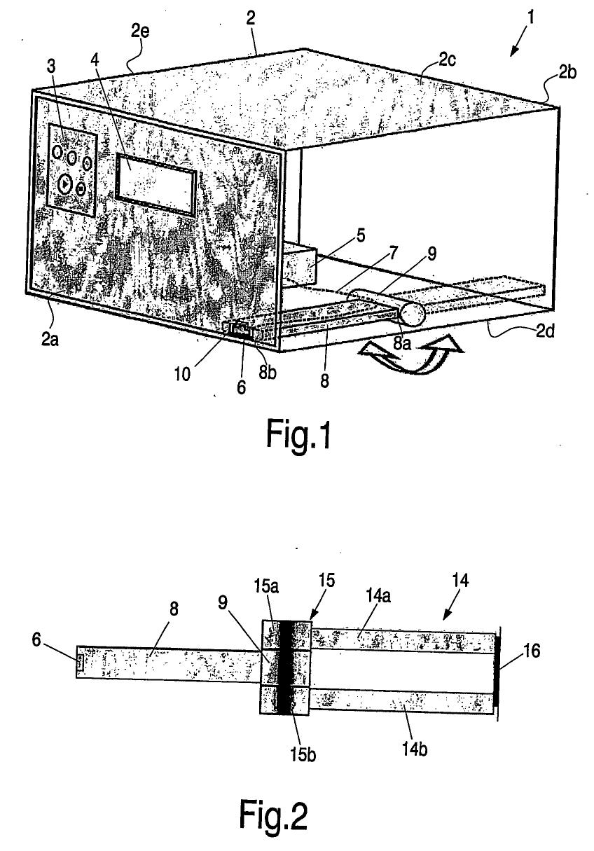

FIG. 1 shows, partly schematically, in an oblique view, a device according to a first example of embodiment of the invention, which device has a pivoting arm as carrier for a modular unit.

FIG. 2 shows, partly schematically, in a plan view, another design of a pivoting arm for a device as shown in FIG. 1.

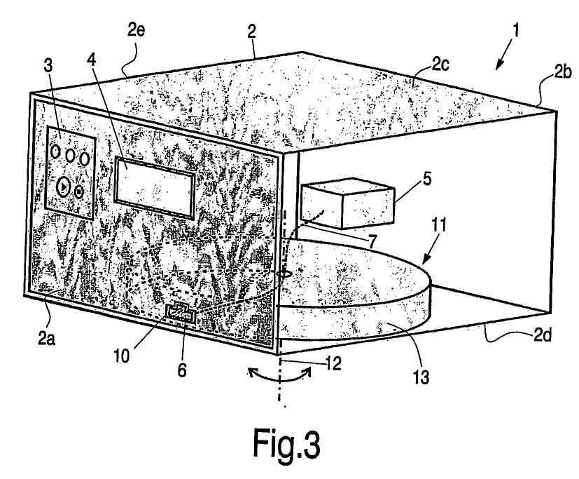

FIG. 3 shows, partly schematically, in an oblique view, a device according to a second example of embodiment of the invention, which device has a modular unit, which modular unit can be positioned by means of a rotating body.

FIG. 1 shows an audio device 1. The audio device 1 is designed to play back audio signals, which audio signals are transmitted over a data network. The audio device 1 has a casing 2, which casing 2 has a front wall 2a, a rear wall 2b, a top wall 2c, a bottom wall 2d and also two side walls 2e. A control panel 3 and a display unit 4 are fitted on or in the front wall 2a in a manner such that they can be accessed and are visible. The control panel 3 comprises a number of buttons, by means of which buttons the audio device 1 can be operated. The display unit 4 serves to display messages or operating states of the audio device 1 and in the present case is formed by what is known as a dot matrix display unit. On the rear wall 2b there is a socket (not shown), by means of which socket the audio device 1 can be supplied with electrical power.

The audio device 1 further has an Internet audio module 5 accommodated in the casing 2, which Internet audio module 5 is designed to receive radio and/or audio signals over a data network. Such an Internet audio module 5 is known, for example, from an audio device mentioned above having the type designation MC-i200. A network jack 6 is provided for connecting the Internet audio module 5 to the data network, by means of which network jack 6 the Internet audio module 5 is connected to connection means 7 which are shown schematically. The network jack 6 is designed as an Ethernet connection and is designed to receive what is known as an RJ-45 connector. The network jack 6 forms a modular unit of the audio device. It may be mentioned that, instead of the Ethernet connection, what is known as a Universal Serial Bus (USB) connection and/or a connection in accordance with the IEEE 1394 standard (FireWire) may be provided, and that, in the audio device, modules having a different functionality can be connected to one of these connections.

The audio device 1 furthermore has a parallelepiped-shaped oblong arm 8 as carrier for a modular unit, which arm 8 has a first end 8a and a second end 8b, where the first end is connected to a bearing spindle 9 by means of which pivoting of the arm 8 is made possible. The bearing spindle 9 is mounted on the bottom wall 2d in a manner such that it can pivot and is in this case arranged approximately in the geometric center between the front wall 2a and the rear wall 2b, with the bearing spindle 9 running parallel to the front wall 2a and the rear wall 2b. In the region of the second end 8b of the arm 8, the network jack 6 is fitted as a modular unit. The network jack 6 is in this case positioned by means of the arm 8 in a first operating position in which the network jack 6 can be accessed from outside the casing 2 through a cutout 10 in the front wall 2a of the casing 2. Advantageously, this means that the network jack 6 can be accessed from the front through the front wall 2a so that a user of the audio device 1 can produce a connection of the audio device 1 or of the Internet audio module 5 to the data network relatively quickly and conveniently, and without having to handle, that is to say move, the audio device 1, specifically by plugging a data network connector into the network jack 6. This may be advantageous, for example, when the data network connector is also to be plugged into the data network jacks of other devices.

An additional advantage of this first operating position of the data network jack in the region of the front of the audio device 1 is that a network connection—on account of the presence of the network jack 6—can advantageously be marketed to a potential purchaser of such an audio device 1.

If, for example, the needs of a user of the audio device 1 then change to the effect that a network connection in the region of the front of the audio device 1 is no longer desired or regarded as advantageous, for example if a network connector is no longer being plugged in frequently and/or for esthetic reasons, then the user of the audio device 1 has the opportunity to place the network jack 6 in a second operating position by pivoting the arm 8, in which second operating position the network jack 6 can advantageously be accessed from the rear or through the rear wall 2b. The arm 8 is pivoted by hand, with auxiliary means (not shown in greater detail) being provided, by means of which auxiliary means easy pivoting from the underside of the audio device 1 through the bottom wall 2d is made possible on account of the fact that corresponding openings are provided in the bottom wall 2d.

When the network jack 6 is in the second operating position, the cutout 10 can where appropriate be closed or covered by means of a suitable matching piece 16 which is matched in particular to the optical properties of the front wall 2a. Such a matching piece 16 can be placed, for example, as in the design shown in FIG. 2, by means of second arm 14 lying opposite the first arm 8, in the corresponding position to cover the cutout 10. The additional second arm 14 is formed of two legs 14a and 14b. The two legs 14a and 14b are in each case connected at a first leg end to a second bearing spindle 15a and 15b, respectively, with the bearing spindle 9 lying between the two bearing spindles 15a and 15b. The matching piece 16 connects the two other leg ends of the legs 14a and 14b. The design is such that the arm 14 and the arm 8 can be pivoted in opposition, where the arm 8 can pass through between the two legs 14a and 14b.

It should be mentioned that it will be easily seen by a person skilled in the art how to change or adapt the form or design of the arm 8, the bearing spindle 9, the cutout 10 and also the position of the bearing spindle 9 and the possibilities for the pivoting of the arm 8.

It should furthermore be mentioned that fixing means may be provided, by means of which fixing means the arm 8 can be fixed once an operating position has been reached. A latching device may be provided as fixing means.

It may be mentioned that the arm 8 may be pivoted automatically by means of motor via a gear, which automatic pivoting can be activated by a button on the control panel 3. As a result, advantageously no openings are needed, as are required in the case of manual pivoting of the arm 8.

It should furthermore be mentioned that, instead of the bearing spindle 9, a ball-and-socket joint may be provided, as a result of which the advantage is obtained that an additional degree of freedom is given in terms of the positioning or spatial alignment of the network jack 6 in the respective operating position.

It may furthermore be mentioned that the Internet audio module 5 or another module having a different functionality, which module is connected to the modular unit, can be accommodated on or in the arm 8, that is to say can be located in the direct vicinity of the network jack 6, in order to be able to design the connection means 7 such that they are relatively short in order to promote improved and distortion-free transmission of signals over the connection means 7.

The second example of embodiment according to the invention shown in FIG. 3 differs from the example of embodiment shown in FIG. 1 in that, instead of the arm 8 and the bearing spindle 9, a cylindrical disk-shaped body 11 is provided as the carrier for a modular unit, by means of which body 11 the modular unit can be positioned in various operating positions. The cylindrical body 11 is mounted such that it can rotate about an axis 12 that runs essentially normal to the bottom wall 2d. The modular unit, in the present case again a network jack 6, is connected to the body 11 and is in this case accommodated in the region of a side surface 13, so that it can move with the cylindrical body 11. It should be mentioned that the network jack 6 may likewise be fitted in the region of a top surface of the cylindrical body 11.

The network jack 6 and the cylindrical body 11 are positioned in a first operating position such that the network jack 6 can be accessed from outside the audio device 1 through the cutout 10 in the front wall 2a of the casing 2. The cylindrical body 11 and consequently the network jack 6 can, if circumstances so require, be placed in another operating position, specifically by rotating the body 11. By means of the present design of the carrier as a cylindrical body 11, the situation is advantageously achieved that the network jack 6 can placed not only in the region of the rear or rear wall 2b, but also in the region of one of the two side walls 2e.

It should be mentioned that matching pieces for covering the operating position that is in each case not assumed can be fitted on the side surface 13.

In the above examples of embodiments, audio devices are used. It should be mentioned that such advantageous measures can also be applied in the case of a TV set, video recorder, hard disk recorder, set-top box, personal computer or laptop or in the case of other devices having a jack.

In the solutions described above, the component that can be adjusted between at least two operating positions is in each case formed by a jack. It should be mentioned that a modular unit can also be formed by a connector for connection to a jack.

It should furthermore be mentioned that a display unit may be provided as adjustable modular unit, which display device can be adjusted for example between an operating position in which it is located in the region of a front wall and an operating position in which it is located in the region of a top wall, in order to ensure either comfortable viewing from the front or comfortable viewing from above.

Moreover, it should be mentioned that a control panel for operating the device may be provided as adjustable modular unit, where the modular unit, that is to say the control panel, can be adjusted, for example, between an operating position in which it is located in the region of a front wall and an operating position in which it is located in the region of a top wall, in order to permit either comfortable operation from the front or comfortable operation from above.

In a device according to the invention, it may furthermore be provided that a modular unit has to be manually grasped in order to move the modular unit from one operating position to at least one other operating position, where the modular unit is held in each operating position by means of holding means so that no carrier is then required for the modular unit.

It may be mentioned that the modular unit (6) may also be named as physical unit (6).

1. A device (1) with a modular unit (6), which modular unit (6) is positioned in an operating position and can be accessed from outside the device (1), characterized in that the modular unit (6) can be positioned in at least one other operating position and in that case too can be accessed from outside the device (1).

2. A device (1) as claimed in claim 1, characterized in that the modular unit (6) can be moved in relation to a device spindle (9; 12).

3. A device (1) as claimed in claim 2, characterized in that a carrier (8; 11) that can pivot about the device spindle (9; 12) is provided and in that the modular unit (6) is connected to the carrier (8; 11) and can be adjusted between its operating positions by pivoting the carrier (8; 11) about the device spindle (9; 12).

4. A device (1) as claimed in claim 3, characterized in that the carrier (8) is designed as a pivoting arm.

5. A device (1) as claimed in claim 3, characterized in that the carrier (11) is designed as a rotating body.

6. A device (1) as claimed in claim 3, characterized in that the carrier (8; 11) is designed to cover the operating position that is in each case not assumed.

7. A device (1) as claimed in claim 1, characterized in that the modular unit (6) is formed by an electrical connector unit.
